(19) United States
(12) Patent Application Publication
(10) Pub. No.: US 2019/0145491 A1
(43) Pub. Date: May 16, 2019

(54) VIBRATION REDUCTION DEVICE

(71) Applicant: EXEDY Corporation, Neyagawa-shi, Osaka (JP)

(72) Inventors: Yusuke TOMITA, Neyagawa-shi, Osaka (JP); Yuki KAWAHARA, Neyagawa-shi, Osaka (JP); Yusuke OKAMOTO, Neyagawa-shi, Osaka (JP)

(21) Appl. No.: 16/308,298

(22) PCT Filed: Jul. 27, 2017
(86) PCT No.: PCT/JP2017/027271

§ 371 Date: Dec. 7, 2018

(30) Foreign Application Priority Data
Aug. 24, 2016 (JP) 2016-163974

(51) Int. Cl. F16F 15/134; F16D 3/12; F16F 15/14; F16F 15/139

(52) U.S. Cl. CPC F16F 15/13469; F16D 3/12; F16F 15/1421; F16F 2232/02; F16D 2300/06; F16F 2222/04; F16F 2222/08; F16F 15/139

(57) ABSTRACT

A vibration reduction device for reducing a torsional vibration from an engine includes an input rotary part, an output rotary part, a damper part, a dynamic vibration absorbing device, and a hysteresis torque generating part. The torsional vibration is input to the input rotary part. The output rotary part is disposed to be relatively rotatable with respect to the input rotary part. The damper part is disposed between the input rotary part and the output rotary part and attenuates the torsional vibration input to the input rotary part. The dynamic vibration absorbing device is for absorbing the torsional vibration output from the damper part. The hysteresis torque generating part is capable of generating a hysteresis torque when the damper part is in operation.

### CROSS-REFERENCES TO RELATED APPLICATIONS

This application is the U.S. National Phase of PCT International Application No. PCT/JP2017/027271, filed on Jul. 27, 2017. That application claims priority to Japanese Patent Application No. 2016-163974, filed Aug. 24, 2016. The contents of both applications are herein incorporated by reference in their entirety.

### BACKGROUND

### Technical Field

The present disclosure relates to a vibration reduction device.

### Background Art

A conventional vibration reduction device is disposed between an engine and a transmission to reduce torsional vibration from the engine. The conventional vibration reduction device includes a housing (flywheel element 3), an output member (flywheel element 4), a damper part (energy accumulator 10) disposed radially outward, and a dynamic vibration absorbing device (vibration attenuator 10) that is disposed farther radially inward than the damper part.

### BRIEF SUMMARY

In the conventional vibration reduction device, when a torsional vibration from the engine is input to the housing, the torsional vibration is attenuated in the damper part. Also, the dynamic vibration absorbing device additionally attenuates the torsional vibration.

In this case, the period between after the start of the engine and until the rotational speed of the engine is stabilized, the rotational speed of the engine is unstable causing an excessive torque fluctuation to be input to the vibration reduction device from the engine, and therefore there is a risk that an excessive torsional vibration might occur in the vibration reduction device.

Also, after the rotational speed of the engine is stabilized, the operation of the dynamic damper device can cause a resonance, for example, a secondary resonance of the vibration reduction device to occur. Therefore, an excessive torsional vibration can occur in the vibration reduction device.

That is, when an excessive torsional vibration as described above occurs in the vibration reduction device, the vibration reduction device cannot completely absorb the torsional vibration, and therefore there is a risk that the torsional vibration might be transmitted from the vibration reduction device to a member on the transmission side.

The present disclosure has been made in view of the above problem, and an object of the present disclosure is to provide a vibration reduction device capable of operating appropriately and capable of attenuating a torsional vibration appropriately.

### Solution to Problem

(1) A vibration reduction device according to one aspect of the present disclosure is for reducing a torsional vibration from an engine. The vibration reduction device includes an input rotary part, an output rotary part, a damper part, a dynamic vibration absorbing device, and a hysteresis torque generating part. The torsional vibration is input to the input rotary part. The output rotary part is disposed so as to be relatively rotatable with respect to the input rotary part. The damper part is disposed between the input rotary part and the output rotary part, and attenuates the torsional vibration input to the input rotary part. The dynamic vibration absorbing device absorbs the torsional vibration output from the damper part. The hysteresis torque generating part is configured to be capable of generating a hysteresis torque at the time of operation of the damper part.

In the present vibration reduction device, the hysteresis torque generating part generates the hysteresis torque when the damper part is in operation, whereby excessive torsional vibration that can occur in the vibration reduction device can be suppressed. As a result, the vibration reduction device can be appropriately operated, and the torsional vibration can be stably attenuated in the vibration reduction device.

(2) In a vibration reduction device according to another aspect of the present disclosure, the input rotary part constitutes an internal space capable of containing lubricating oil. The damper part, the dynamic vibration absorbing device, and the hysteresis torque generating part are disposed in the internal space.

In this case, disposing the damper part, the dynamic vibration absorbing device, and the hysteresis torque generating part in the internal space of the input rotary part in a state where the lubricating oil is contained in the internal space of the input rotary part makes it possible to stably operate the damper part, the dynamic vibration absorbing device, and the hysteresis torque generating part.

(3) In a vibration reduction device according to yet another aspect of the present disclosure, the hysteresis torque generating part operates in parallel with the damper part.

Operating the hysteresis torque generating part in this manner allows the hysteresis torque to be suitably generated at the time of operation of the damper part.

(4) In a vibration reduction device according to yet another aspect of the present disclosure, the damper part includes a first rotary member, a second rotary member, and a first elastic member. The first rotary member is coupled to the input rotary part. The second rotary member is disposed so as to be relatively rotatable with respect to the first rotary member, and is coupled to the output rotary part. The first elastic member elastically couples the first rotary member and the second rotary member. The hysteresis torque generating part is disposed between the first rotary member and the second rotary member. The hysteresis torque generating part generates a hysteresis torque according to a relative torsional angle of the first rotary member and the second rotary member.

With this configuration in which the hysteresis torque generating part is configured in this manner, the hysteresis torque can be suitably generated at the time of operation of the damper part.

(5) In a vibration reduction device according to yet another aspect of the present disclosure, the hysteresis torque generating part includes an engaging part and a friction part. The engaging part is engaged with either one of the first rotary member or the second rotary member. The friction part is held between the engaging part and either one of the other first rotary member or the other second rotary member.

With this configuration in which the hysteresis torque generating part is configured in this manner, the hysteresis torque can be suitably generated at the time of operation of the damper part.

In a vibration reduction device according to yet another aspect of the present disclosure, the engaging part includes a first engaging member. The friction part includes a first friction member. The first engaging member is relatively rotatable with respect to either one of the first rotary member or the second rotary member in a range of a first torsional angle. The first engaging member is integrally rotatable with either one of the first rotary member or the second rotary member outside the range of the first torsional angle.

The first friction member is slidable with respect to at least one of the first engaging member and the other either one of the first rotary member or the second rotary member outside the range of the first torsional angle.

With this configuration in which the hysteresis torque generating part is configured in this manner, the hysteresis torque can be suitably generated by the frictional resistance of the first friction member outside the range of the first torsional angle.

In a vibration reduction device according to yet another aspect of the present disclosure, the engaging part further includes a second engaging member. The friction part further includes a second friction member. The second engaging member is relatively rotatable with respect to either one of the first rotary member or the second rotary member in a range of a second torsional angle that is larger than the range of the first torsional angle. The second engaging member is integrally rotatable with either one of the first rotary member or the second rotary member outside the range of the second torsional angle.

The second friction member is slidable with respect to at least one of the second engaging member and the other either one of the first rotary member or the second rotary member outside the range of the second torsional angle.

With this configuration in which the hysteresis torque generating part is configured in this manner, the hysteresis torque can be suitably generated by the frictional resistance of the second friction member outside the range of the second torsional angle.

(8) In a vibration reduction device according to yet another aspect of the present disclosure, the dynamic vibration absorbing device is disposed side by side with the damper part in a direction along a rotational axis of the input rotary part.

In this case, the dynamic vibration absorbing device can be effectively operated without receiving restrictions in the arrangement thereof due to the damper part. For example, it is possible to dispose the dynamic vibration absorbing device radially outward; thus allowing the dynamic vibration absorbing device to be effectively operated.

(9) In a vibration reduction device according to yet another aspect of the present disclosure, the damper part includes a first rotary member, a second rotary member, and a first elastic member. The first rotary member is coupled to the input rotary part. The second rotary member is disposed so as to be relatively rotatable with respect to the first rotary member. The second rotary member is coupled to the output rotary part. The first elastic member elastically couples the first rotary member and the second rotary member to each other.

Even if the damper part is configured in the manner now being exemplified, the vibration reduction device can be appropriately operated, and the torsional vibration can be stably attenuated in the vibration reduction device.

(10) In a vibration reduction device according to yet another aspect of the present disclosure, the dynamic vibration absorbing device includes an input member and an inertia mass body. The torsional vibration output from the damper part is input to the input member. The inertia mass body is configured to be relatively movable with respect to the input member.

Even if the dynamic vibration absorbing device is configured in the manner now being exemplified, the vibration reduction device can be appropriately operated, and the torsional vibration can be stably attenuated in the vibration reduction device.

(11) In a vibration reduction device according to yet another aspect of the present disclosure, the dynamic vibration absorbing device further includes a second elastic member that elastically couples the input member and the inertia mass body.

In this case, the inertia mass body is configured to be relatively movable with respect to the input member via the second elastic member. Even with such a configuration, the torsional vibration can be effectively absorbed in the dynamic vibration absorbing device.

(12) In a vibration reduction device according to yet another aspect of the present disclosure, each of the plurality of inertia mass bodies is pivotably supported by the input member with reference to a pivot center that is farther radially outward than the rotational axis of the input rotary part.

In this case, pivoting the inertia mass body with respect to the input member allows the torsional vibration to be effectively absorbed in the dynamic vibration absorber.

(13) In a vibration reduction device according to yet another aspect of the present disclosure, the dynamic vibration absorbing device further includes a centrifugal element. The centrifugal element engages with the inertia mass body by a centrifugal force. The centrifugal element guides the inertia mass body so that the relative displacement between the input member and the inertia mass body is reduced. Even with such a configuration, the torsional vibration can be effectively absorbed in the dynamic vibration absorbing device.

According to the present disclosure, the vibration reduction device can be appropriately operated, and it is possible to appropriately attenuate the torsional vibration in the vibration reduction device.

### BRIEF DESCRIPTION OF THE DRAWINGS

FIG. 1 is a cross-sectional configuration diagram of a vibration reduction device according to an exemplary embodiment of the present disclosure.

FIG. 2 is a diagram of a main damper device extracted from the vibration reduction device in FIG. 1.

FIG. 3A is a diagram of a hysteresis torque generating mechanism extracted from the vibration reduction device in FIG.1.

FIG. 3B is a diagram of the hysteresis torque generating mechanism extracted from the vibration reduction device in FIG.1.

FIG. 4 is a diagram for explaining an operation range of the hysteresis torque generating mechanism.

FIG. 5 is a diagram of a dynamic damper device extracted from the vibration reduction device in FIG. 1.

FIG. 6 is a partial side view of a damper plate part of the dynamic damper device.

FIG. 7 is a partial side view of an inertia part of the dynamic damper device.

FIG. 8 is a partial side view of a lid member of the dynamic damper device.

FIG. 9 is a partial cross-sectional view of the dynamic damper device.

FIG. 10 is a diagram illustrating a hysteresis torque generating mechanism according to another exemplary embodiment of the present disclosure.

FIG. 11 is a partial side view of a dynamic damper device according to another exemplary embodiment of the present disclosure.

FIG. 12 is a partial side view of a dynamic damper device according to another exemplary embodiment of the present disclosure.

### DETAILED DESCRIPTION OF THE PREFERRED EMBODIMENTS

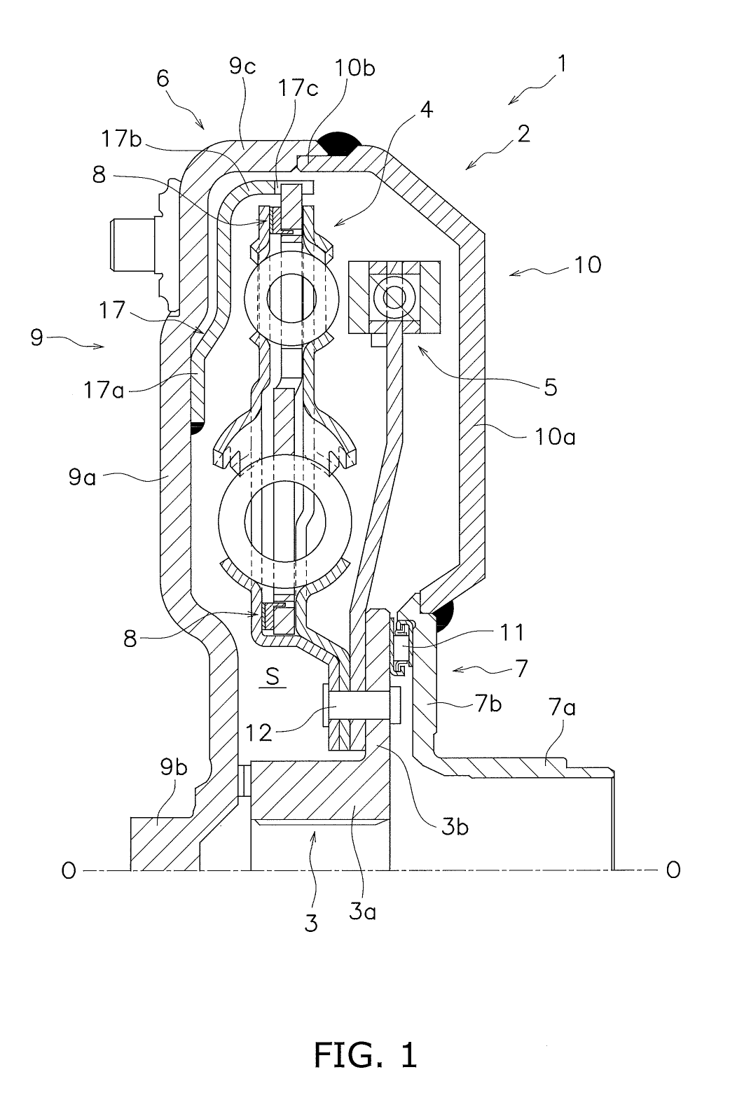

FIG. 1 is a partial cross-sectional view of a vibration reduction device according to an exemplary embodiment of the present disclosure. In FIG. 1, an engine (not shown in the drawing) is disposed on the left side whereas a transmission (not shown in the drawing) is disposed on the right side of the drawing. It should be noted that a line O-O depicted in FIG. 1 indicates a rotational axis of a vibration reduction device 1. It should also be noted that hereinafter, a direction away from the rotational axis O may be referred to as “radial direction”; a direction along the rotational axis O may be referred to as “axial direction”; and a direction around the rotational axis O may be referred to as “circumferential direction”.

### Overall Configuration of the Vibration Reduction Device

The vibration reduction device 1 is a device for transmitting a torque from a member on the engine side to a member on the transmission side. Further, the vibration reduction device 1 is configured to be capable of reducing torsional vibration from the engine. The torsional vibration is a torsional vibration occurring in the vibration reduction device 1 due to torque fluctuation (rotation speed variation) input from the engine to the vibration reduction device 1.

As shown in FIG. 1, the vibration reduction device 1 includes a housing 2 (an example of an input rotary part), an output hub 3 (an example of an output rotary part), a main damper device 4 (an example of a damper part), a hysteresis torque generating mechanism 8 (an example of a hysteresis torque generating part), and a dynamic damper device 5 (an example of a dynamic vibration absorbing device).

<Housing>

A member on the engine side is attached to the housing 2, and the torque of the engine is input therein. As shown in FIG. 1, the housing 2 is configured to be rotatable around the rotational axis O.

The housing 2 has a cover part 6, a cover part hub 7, and a coupling plate 17. The housing 2 constitutes an internal space S. The internal space S is configured to be capable of containing lubricating oil. In this case, the internal space S is formed by the cover part 6. It may be construed that the internal space S is formed by the cover part 6 and the cover part hub 7. Furthermore, the interior space S may be construed as being formed by the housing 2 and the output hub 3.

(Cover Part 6)

The cover part 6 includes a first cover 9 and a second cover 10. The first cover 9 is a cover member on the engine side. The first cover 9 includes a first main body 9a, a boss part 9b, and a first outer peripheral cylindrical part 9c.

The first main body part 9a is formed in a substantially disc shape. The boss part 9b is provided on the inner peripheral part of the first main body part 9a. The boss part 9b protrudes from the inner peripheral part of the first main body part 9a toward the engine side. The boss part 9b is inserted into a crankshaft (not shown). The first outer peripheral cylindrical part 9c is provided on the outer peripheral part of the first main body part 9a. The first outer peripheral cylindrical part 9c protrudes from the outer peripheral part of the first main body part 9a toward the transmission side.

The second cover 10 is a cover member on the transmission side. The second cover 10 has a second main body part 10a and a second outer peripheral cylindrical part 10b. The second main body part 10a is formed in a substantially annular shape. An inner peripheral part of the second main body part 10a is fixed to the cover part hub 7 by welding. The second outer peripheral cylindrical part 10b is provided on the outer peripheral part of the second main body part 10a. The second outer peripheral cylindrical part 10b protrudes from the outer peripheral part of the second main body part 10a toward the engine side. The second outer peripheral cylindrical part 10b is fixed to the first outer peripheral cylindrical part 9c of the first cover 9 by welding.

<Cover Part Hub>

The cover part hub 7 is supported so as to be relatively rotatable with respect to the output hub 3. For example, the cover part hub 7 is supported by the output hub 3 via a bearing or a thrust washer 11. It should be noted that the cover part hub 7 may be construed as a member constituting the internal space S of the housing 2.

Specifically, the cover part hub 7 has a first hub main body 7a and a first hub flange 7b. The first hub main body 7a is substantially formed in a cylindrical shape. The first hub flange 7b is integrally formed with the first hub main body 7a. The first hub flange 7b protrudes radially outward from the outer peripheral part of the first hub body 7a. An inner peripheral part of the second main body part 10a of the second cover 10 is fixed to the first hub flange 7b by welding.

<Coupling Plate>

The coupling plate 17 couples the cover part 6 and the main damper device 4. The coupling plate 17 is fixed to the cover part 6 and engages with the main damper device 4.

Specifically, the coupling plate 17 has a third body part 17a and a third outer peripheral cylindrical part 17b. The third main body part 17a is formed in a substantially annular shape. An inner peripheral part of the third main body part 17a is fixed to the cover part 6, for example, an inner surface of the first cover 9 by fixing means such as welding or riveting.

The third outer peripheral cylindrical part 17b is provided on an outer peripheral part of the third main body part 17a. The third outer peripheral cylindrical part 17b protrudes from the outer peripheral part of the third main body part 17a towards the side of the main damper device 4. A plurality of engaging recess parts 17c are formed at the distal end of the third outer peripheral cylindrical part 17b. The plurality of engaging recess parts 17c are each disposed at predetermined intervals in the circumferential direction. The plurality of engaging recess parts 17c are respectively engaged with a plurality of engaging protrusions 13b (to be described later) of the main damper device 4.

<Output Hub>

The output hub 3 is disposed so as be relatively rotatable with respect to the housing 2. The output hub 3 is disposed in the internal space S of the housing 2. It should be noted that the output hub 3 may be construed as a member constituting the internal space S of the housing 2.

A member on the transmission side is attached to the output hub 3. The output hub 3 is mounted so as to be integrally rotatable with a shaft (not shown) on the transmission side.

Specifically, the output hub 3 has a second hub main body 3a and a second hub flange 3b. The second hub main body 3a is substantially formed in a cylindrical shape. An inner peripheral part of the second hub main body 3a engages with the shaft of the transmission side so as to be integrally rotatable therewith. In this case, the inner peripheral part of the second hub main body 3a is spline-engaged with the outer peripheral part of the shaft on the transmission side.

The second hub flange 3b is integrally formed with the second hub main body 3a. The second hub flange 3b protrudes radially outward from an outer peripheral part of the second hub main body 3a. The main damper device 4 and the dynamic damper device 5 are fixed to the second hub flange 3b by fixing means, for example, a rivet 12. The above-described bearing or thrust washer 11 is disposed between the second hub flange 3b and the first hub flange 7b of the cover part hub 7 in the axial direction.

<Main Damper Device>

The main damper device 4 attenuates the torsional vibration input into the housing 2. As shown in FIG. 1, the main damper device 4 is disposed in the internal space S of the housing 2.

The main damper device 4 is disposed closer to the engine side than the dynamic damper device 5 in the axial direction. In other words, the main damper device 4 is disposed between the engine and the dynamic damper device 5 in the axial direction. Specifically, the main damper device 4 is disposed between the housing 2 on the engine side and the dynamic damper 5 in the axial direction. More specifically, the main damper device 4 is disposed between the first cover 9 of the housing 2 and the dynamic damper device 5 in the axial direction.

The main damper device 4 couples the housing 2 and the output hub 3. The main damper device 4 is coupled to the housing 2 via the coupling plate 17. In this case, the main damper device 4 is coupled to the housing 2 so as to be integrally rotatable therewith via the coupling plate 17. Further, the main damper device 4 is coupled to the output hub 3. In this case, the main damper device 4 is fixed to the output hub 3 by fixing means such as the plurality of rivets 12.

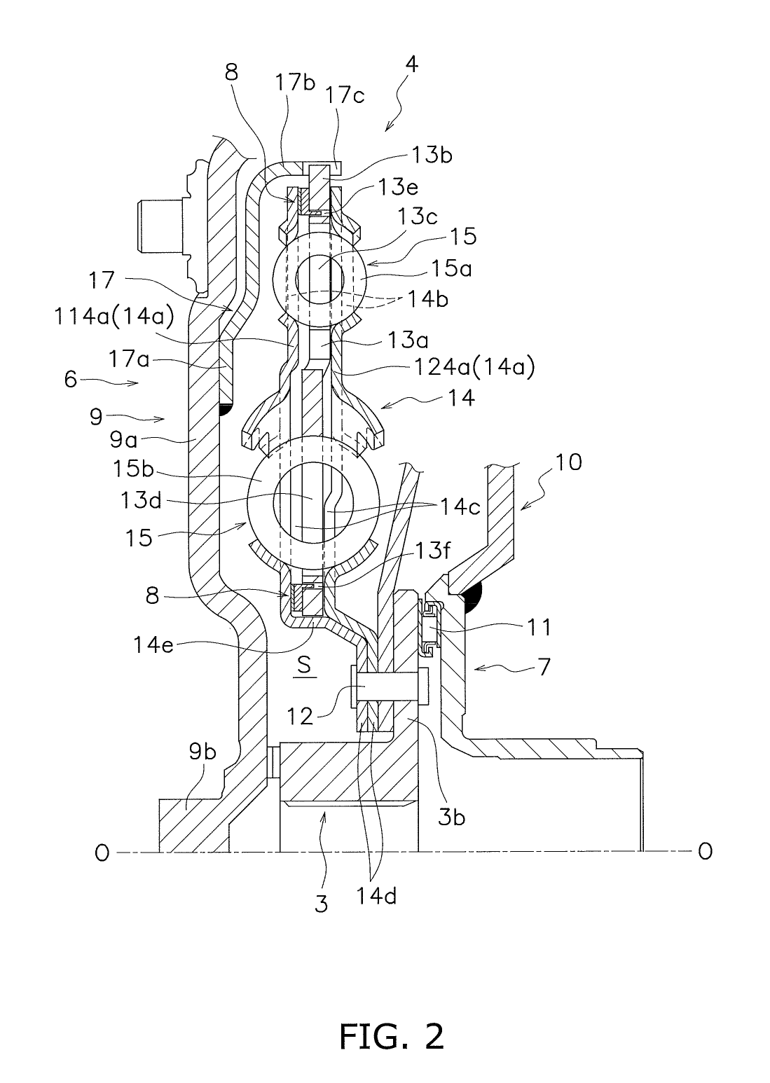

Specifically, as shown in FIG. 2, the main damper device 4 includes a drive plate 13 (an example of a first rotary member), a driven plate 14 (an example of a second rotary member), and a plurality of coil springs 15 (an example of a first elastic member).

(Drive Plate)

The drive plate 13 is rotatably disposed with respect to the driven plate 14. Further, the drive plate 13 is rotatably supported with respect to the driven plate 14.

As shown in FIG. 2, the drive plate 13 is coupled to the housing 2. In this case, the drive plate 13 is coupled to the cover part 6 of the housing 2 via the connection plate 17 so as to be integrally rotatable therewith.

Specifically, the drive plate 13 is configured to be integrally rotatable with the coupling plate 17 fixed to the cover part 6 of the housing 2. In this case, the drive plate 13 is engaged with the third outer peripheral cylindrical part 17b of the coupling plate 17 so as to be integrally rotatable with the coupling plate 17.

In particular, the drive plate 13 includes a drive plate main body 13a, a plurality of engaging protrusions 13b, a plurality of first outer peripheral side window parts 13c (for example, four), a plurality of inner peripheral side window parts 13d (for example, four), a plurality of first hole parts 13e (for example, four), and a plurality of second hole parts 13f (for example, four).

The drive plate main body 13a is substantially annular and formed into a disc shape.

The plurality of engaging protrusions 13b are formed on an outer peripheral part of the drive plate main body 13a. Specifically, each of the plurality of engaging protrusions 13b protrudes radially outward from the outer peripheral part of the drive plate main body 13a. The plurality of engaging protrusions 13b are disposed at predetermined intervals in the circumferential direction. The plurality of engaging protrusions 13b are respectively engaged with the plurality of engaging recess parts 17c of the coupling plate 17 (third outer peripheral cylindrical part 17b). Specifically, each of the engaging protrusions 13b is disposed inside each of the engaging recess parts 17c. This configuration allows the drive plate 13 to rotate integrally with the coupling plate 17.

The plurality of first outer peripheral side window parts 13c are provided on the outer peripheral side of the drive plate main body 13a. Specifically, the first outer peripheral side window parts 13c are provided on the drive plate main body 13a at predetermined intervals in the circumferential direction. A plurality of outer peripheral side coil springs 15a (to be described later) are disposed in the first outer peripheral side window parts 13c respectively.

The plurality of first inner peripheral side window parts 13d are provided on an inner peripheral side of the drive plate main body 13a. Specifically, the first inner peripheral side window parts 13d are provided on the drive plate main body 13a at predetermined intervals in the circumferential direction farther on the radially inner peripheral side than the plurality of first outer peripheral side window parts 13c. A plurality of inner peripheral side coil springs 15b (to be described later) are respectively disposed in the first inner peripheral side window parts 13d.

The plurality of first hole parts 13e are provided on an outer peripheral part of the drive plate main body 13a. Specifically, each of the first hole parts 13e is provided on the outer peripheral part of the drive plate main body 13a at a predetermined interval in the circumferential direction. Each of the first hole parts 13e penetrates the drive plate main body 13a in the axial direction. In each of the first hole parts 13e, a radially outer wall part and a radially inner wall part extend in a circular-arc shape in the circumferential direction. Each of a first engaging protrusions 20b (to be described later) of the first engaging member of the hysteresis torque generating mechanism 8 is engaged with each of the first hole parts 13e.

The plurality of second hole parts 13f are provided in the inner peripheral part of the drive plate main body 13a. Specifically, each of the second hole parts 13f is provided on the inner peripheral part of the drive plate main body 13a at a predetermined interval in the circumferential direction. Each of the second hole parts 13f penetrates the drive plate main body 13a in the axial direction. In each of the second hole parts 13f, a radially outer wall part and a radially inner wall part extend in a circular-arc shape in the circumferential direction. A second engaging protrusions 21b (to be described later) of the second engaging member of the hysteresis torque generating mechanism 8 are respectively engaged with the second hole parts 13f.

(Driven Plate)

The driven plate 14 is rotatably disposed with respect to the drive plate 13. As shown in FIG. 2, the driven plate 14 is coupled to the output hub 3.

The driven plate 14 includes a pair of driven plate bodies 14a, a plurality of second outer peripheral side window parts 14b, and a plurality of second inner peripheral side window parts 14c.

Each of the two driven plate bodies 14a is substantially annular and formed into a disc shape.

The pair of driven plate main bodies 14a are arranged facing each other in the axial direction. The drive plate 13 (drive plate main body 13a) is disposed between the pair of driven plate main bodies 14a in the axial direction. One of the driven plate main bodies 14a is disposed on the engine side with reference to the drive plate 13. The other driven plate 14 is disposed on the transmission side with reference to the drive plate 13.

Note that in the following description, one of the driven plate main bodies 14a may be referred to as a first driven plate main body 114a. In addition, the other driven plate main body 14a may be referred to as a second driven plate main body 124a.

More specifically, the inner peripheral parts of the first and second driven plate main bodies 114a and 124a (14a), for example, first fixing parts 14d are arranged adjacent to each other in the axial direction and fixed to the second hub flange 3b of the output hub 3 by fixing means, for example, the plurality of rivets 12. The first and second driven plate main bodies 114a and 124a (excluding the first fixing parts 14d) are disposed with a predetermined interval between each other in the axial direction. The drive plate 13 (drive plate main body 13a) is disposed in this interval. That is, the drive plate 13 is disposed between the first and second driven plate main bodies 114a and 124a (14a).

The first driven plate main body 114a is provided with a support part 14e for supporting the inner peripheral part of the drive plate 13 (drive plate main body 13a). The support part 14e is provided on the outer peripheral side of the first fixed part of the first driven plate main body 114a. The support part 14e is formed in an annular shape. An inner peripheral part of the drive plate 13 (drive plate main body 13a) is disposed on an outer peripheral surface of the support part 14e. In this way, the first driven plate main body 114a positions the drive plate 13 (drive plate main body 13a) on the support part 14e in the radial direction.

The plurality of second outer peripheral side window parts 14b are provided on the outer peripheral sides of the pair of driven plate main bodies 14a (the first driven plate main body 114a and the second driven plate main body 124a), respectively. Specifically, each of the second outer peripheral side window parts 14b is provided in each of the two driven plate main bodies 14a at a predetermined interval in the circumferential direction. Each of the second outer peripheral side window parts 14b and each of the first outer peripheral side window parts 13c of the drive plate main body 13a are arranged to face each other in the axial direction. The plurality of outer peripheral side coil springs 15a (which will be described later) are each disposed in each of the second outer peripheral side window parts 14b and each of the first outer peripheral side window parts 13c.

The plurality of second inner peripheral side window parts 14c are provided on the inner peripheral sides of the pair of driven plate main bodies 14a (the first driven plate main body 114a and the second driven plate main body 124a), respectively. Specifically, each of the second inner peripheral side window parts 14c is provided in each of the two driven plate main bodies 14a at a predetermined interval in the circumferential direction. Each of the second inner peripheral side window parts 14c and each of the first inner peripheral side window parts 13d of the drive plate main body 13a are arranged to face each other in the axial direction. The plurality of inner peripheral side coil springs 15b (which will be described later) are each disposed in each of the second inner peripheral side window parts 14c and each of the first inner peripheral side window parts 13d.

(Coil Spring)

The plurality of coil springs 15 elastically couples the drive plate 13 and the driven plate 14 to each other. Specifically, as shown in FIG. 2, the plurality of coil springs 15 include a plurality of outer peripheral side coil springs 15a (for example, four) and a plurality of inner peripheral side coil springs 15b (for example, four). With this configuration, the plurality of outer peripheral side coil springs 15a and the plurality of inner peripheral side coil springs 15b operate in parallel between the drive plate 13 and the driven plate 14.

Each of the plurality of outer peripheral side coil springs 15a elastically couples the drive plate 13 and the driven plate 14 to each other. The outer peripheral side coil springs 15a are respectively disposed onto the first outer peripheral side window parts 13c of the drive plate 13 and the second outer peripheral side window parts 14b of the driven plate 14.

The outer peripheral side coil springs 15a respectively abuts against both the first outer peripheral side window parts 13c and the second outer peripheral side window parts 14b in the circumferential direction. Specifically, each of the outer peripheral side coil springs 15a abuts against a wall part of each of the first outer peripheral side window parts 13c and a wall part of each of the second outer peripheral side window parts 14b. In addition, the cut-raised parts of the second outer peripheral side window parts 14b respectively prevent the outer peripheral side coil springs 15a from jumping out in the axial direction.

The plurality of inner peripheral side coil springs 15b each elastically couples the drive plate 13 and the driven plate 14 to each other. The inner peripheral side coil springs 15b are respectively disposed onto the first inner peripheral side window parts 13d of the drive plate 13 and the second inner peripheral side window parts 14c of the driven plate 14.

The inner peripheral side coil springs 15b respectively abut against the first inner peripheral side window parts 13d and the second inner peripheral side window parts 14c in the circumferential direction. Specifically, each of the inner peripheral side coil springs 15b abuts against a wall part of each of the first inner peripheral side window parts 13d and a wall part of each of the second inner peripheral side window parts 14c. In addition, the cut-raised parts of the second inner peripheral side window parts 14c respectively prevent the inner peripheral side coil springs 15b from jumping out in the axial direction.

Adopting a configuration that constitutes the plurality of coil springs 15 (the plurality of outer peripheral side coil springs 15a and the plurality of inner peripheral side coil springs 15b) allows at least a part of the plurality of coil springs 15 to be disposed side by side with an inertia part 51 (to be described later) of the dynamic damper device 5 in the axial direction. For example, at least a part of the outer peripheral side coil spring 15a is disposed side by side with the inertia part 51 in the axial direction. More specifically, a part of the outer peripheral side coil spring 15a is disposed side by side with the inertia part 51 in the axial direction.

<Hysteresis Torque Generating Mechanism>

The hysteresis torque generating mechanism 8 is configured to be capable of generating a hysteresis torque at the time of operation of the main damper device 4. Here, the hysteresis torque generating mechanism 8 is configured to be capable of generating a variable hysteresis torque according to the torsional angle in the main damper device 4. The hysteresis torque generating mechanism 8 operates in parallel with the main damper device 4.

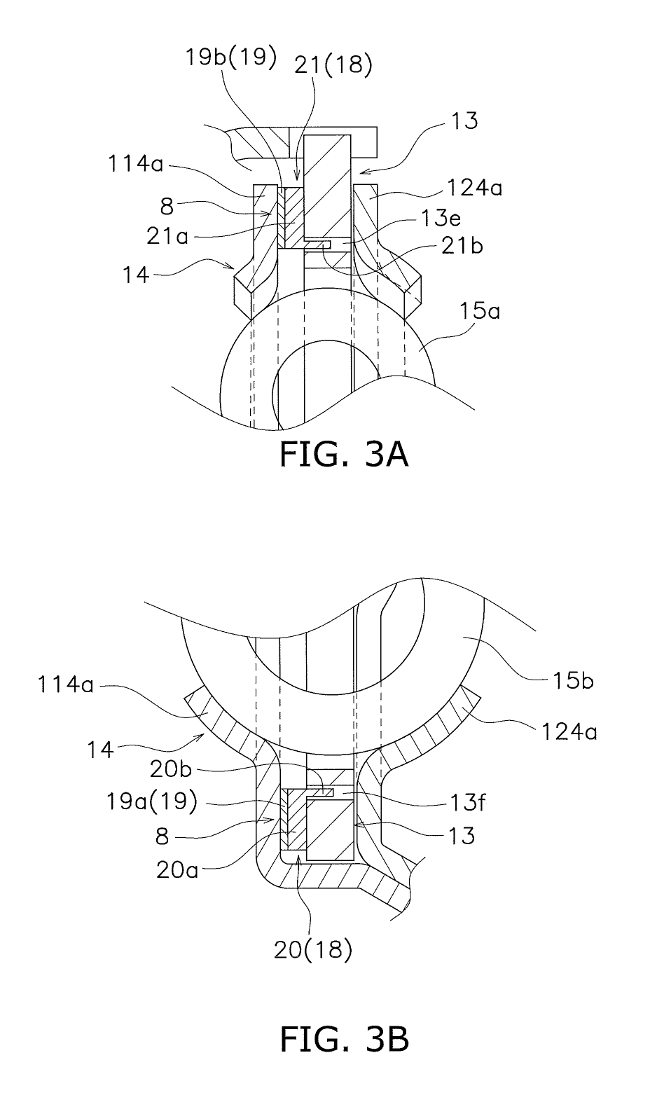

As shown in FIG. 2, the hysteresis torque generating mechanism 8 is disposed in the internal space S of the housing 2. More specifically, the hysteresis torque generating mechanism 8 is disposed between the drive plate 13 and the driven plate 14 in the main damper device 4. The hysteresis torque generating mechanism 8 generates a hysteresis torque according to the relative torsional angle of the drive plate 13 and the driven plate 14. Specifically, as shown in FIG. 3, the hysteresis torque generating mechanism 8 includes an engaging part 18 and a friction part 19.

It should be noted that the hysteresis torque generating mechanism 8 operates in cooperation with the drive plate 13 and the driven plate 14, and therefore can include the drive plate 13 and the driven plate 14.

(Engaging Part)

The engaging part 18 is engaged with either one of the drive plate 13 or the driven plate 14. In this case, the engaging part 18 is engaged with the drive plate 13. Specifically, as shown in FIGS. 3A and 3B, the engaging part 18 includes a first engaging member 20 and a second engaging member 21.

As shown in FIG. 3B, the first engaging member 20 is configured to be engageable with either one of the drive plate 13 or the driven plate 14. In this case, the first engaging member 20 is engaged with the drive plate 13, for example, the plurality of second hole parts 13f.

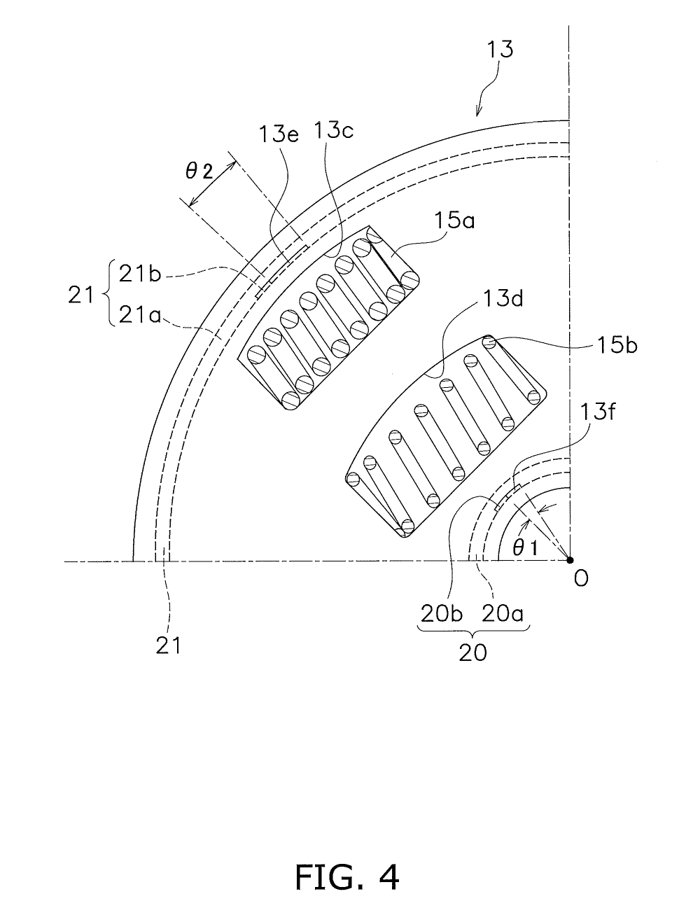

As shown in FIG. 4, the first engaging member 20 is configured to be relatively rotatable with respect to the drive plate 13 within the range of a first torsional angle θ1. In addition, the first engaging member 20 is configured to be integrally rotatable with the driven plate 14 via a first friction member 19a (to be described later) of the friction part 19 within the range of the first torsional angle θ1.

The first engaging member 20 is configured to be integrally rotatable with the drive plate 13 outside the range of the first torsional angle θ1. In addition, the first engaging member 20 is configured to be relatively rotatable with respect to the driven plate 14 via the first friction member 19a outside the range of the first torsional angle θ1.

Specifically, as shown in FIG. 3B, the first engaging member 20 includes a fourth main body 20a and a plurality of first engaging protrusions 20b (for example, four). The fourth main body part 20a is formed in a substantially annular shape. The fourth main body 20a is disposed between the drive plate 13 and the second driven plate main body 124a in the axial direction.

The plurality of first engaging protrusions 20b are provided on the fourth main body 20a. Specifically, the plurality of first engaging protrusions 20b are each formed integrally with the fourth main body 20a at predetermined intervals in the circumferential direction. Each of the first engaging protrusions 20b extends in the axial direction in the inner peripheral part of the fourth main body 20a. In this case, each of the first engaging protrusions 20b extends from the inner peripheral part of the fourth main body 20a towards the drive plate 13. Each of the first engaging protrusions 20b is disposed in each of the second hole parts 13f of the drive plate 13.

As shown in FIG. 4, a circumferential width of each first engaging protrusion 20b is smaller than a circumferential width of each second hole part 13f of the drive plate 13. Hence, each of the first engaging protrusions 20b is movable in the circumferential direction inside each of the second hole parts 13f. Further, each of the first engaging protrusions 20b can make contact with a circumferential wall portion of each of the second hole parts 13f.

For example, each of the first engaging protrusions 20b moves in the circumferential direction within each of the second hole parts 13f (the range of the first torsional angle θ1) until it comes into contact with the circumferential wall portions of the second hole parts 13f With this configuration, the first engaging member 20 relatively rotates with respect to the drive plate 13 within the range of the first torsional angle θ1, and rotates integrally with the drive plate 13 outside the range of the first torsional angle θ1.

As shown in FIG. 3A, the second engaging member 21 is configured to be engageable with either one of the drive plate 13 or the driven plate 14. In this case, the second engaging member 21 is engaged with the drive plate 13, for example, the plurality of first hole parts 13e.

As shown in FIG. 4, the second engaging member 21 is configured to be relatively rotatable with respect to the drive plate 13 within the range of a second torsional angle θ2. In addition, the second engaging member 21 is configured to be integrally rotatable with the driven plate 14 via a second friction member 19b (to be described later) of the friction part 19 within the range of the second torsional angle θ2. Here, the second torsional angle θ2 is larger than the second torsional angle θ1.

The second engaging member 21 is configured to be integrally rotatable with the drive plate 13 outside the range of the second torsional angle θ2. In addition, the second engaging member 21 is configured to be relatively rotatable with respect to the driven plate 14 via the second friction member 19b outside the range of the second torsional angle θ2.

Specifically, as shown in FIG. 3A, the second engaging member 21 includes a fifth main body 21a and a plurality of second engaging protrusions 21b (for example, four). The fifth main body part 21a is formed in a substantially annular shape. The fifth main body 21a is disposed between the drive plate 13 and the first driven plate main body 114a in the axial direction.

The plurality of second engaging protrusions 21b are provided on the fifth main body 21a. Specifically, the plurality of second engaging protrusions 21b is formed integrally with the fifth main body 21a at a predetermined interval in the circumferential direction. Each of the second engaging protrusions 21b extends in the axial direction in the inner peripheral part of the fifth main body 21a. In this case, each of the second engaging protrusions 21b extends from the inner peripheral part of the fifth main body 21a towards the drive plate 13. Each of the second engaging protrusions 21b is disposed in each of the first hole parts 13e of the drive plate 13.

As shown in FIG. 4, a circumferential width of each second engaging protrusion 21b is smaller than a circumferential width of each first hole part 13e of the drive plate 13. Hence, each of the second engaging protrusions 21b is movable in the circumferential direction inside each of the first hole parts 13e. Further, each of the second engaging protrusions 21b can make contact with a circumferential wall portion of each of the first hole parts 13e.

For example, each of the second engaging protrusions 21b moves in the circumferential direction within each of the first hole parts 13e (the range of the second torsional angle θ2) until it comes into contact with the circumferential wall portions of the first hole parts 13e. With this configuration, the second engaging member 21 relatively rotates with respect to the drive plate 13 within the range of the second torsional angle θ2, and rotates integrally with the drive plate 13 outside the range of the second torsional angle θ2.

(Friction Part)

The friction part 19 is held between the engaging part 18 and either one of the other drive plate 13 or the other driven plate 14. In this case, the friction part 19 is disposed between the engaging part 18 and the driven plate 14 in the axial direction and is held therebetween. More specifically, as shown in FIGS. 3A and 3B, the friction part 19 includes the first friction member 19a and the second friction member 19b.

The first friction member 19a is configured to be able to make contact with the first engaging member 20 and either one of the drive plate 13 or the driven plate 14. The first friction member 19a is configured to be slidable with respect to either one of the first engaging member 20 or the driven plate 14 outside the range of the first torsional angle θ1.

Specifically, the first friction member 19a is formed in a substantially annular shape. The first friction member 19a is attached to the first engaging member 20 (the fourth main body 20a) and is integrally rotatable therewith. The first friction member 19a is in contact with the second driven plate main body 124a and is integrally rotatable with the second driven plate main body 124a as well as slidable with respect thereto.

Specifically, each of the first friction members 19a is in contact with the second driven plate main body 124a in the range of the first torsional angle θ1 and rotates integrally with the second driven plate main body 124a. That is, the first engaging member 20, to which each of the first friction members 19a is attached, rotates integrally with the driven plate 14 (the first driven plate main body 114a and the second driven plate main body 124a) and relatively rotates with respect to the drive plate 13 in the range of the first torsional angle θ1. In this case, substantially no hysteresis torque is generated between each of the first friction members 19a and the driven plate 14 (the first driven plate main body 114a); however, a first hysteresis torque is generated due to the mechanical friction of each component of the vibration reduction device 1.

Conversely, each of the first friction members 19a slides with the second driven plate main body 124a outside the range of the first torsional angle θ1. That is, the first engaging member 20, to which each of the first friction members 19a is attached, rotates integrally with the drive plate 13 and relatively rotates with respect to the driven plate 14 (the first driven plate main body 114a and the second driven plate main body 124a) outside the range of the first torsional angle θ1. In this case, the friction between each of the first friction member 19a and the driven plate 14 (first driven plate main body 114a) generates a second hysteresis torque.

The second friction member 19b is configured to be able to make contact with the second engaging member 21 and either one of the drive plate 13 or the driven plate 14. The second friction member 19b is configured to be slidable with respect to either one of the second engaging member 21 or the driven plate 14 outside the range of the second torsional angle θ2.

Specifically, the second friction member 19b is formed in a substantially annular shape. The second friction member 19b is attached to the second engaging member 21 (the fifth main body 21a) and is integrally rotatable therewith. The second friction member 19b is in contact with the second driven plate main body 124a and is integrally rotatable with the second driven plate main body 124a as well as slidable with respect thereto.

Specifically, each of the second friction members 19b is in contact with the second driven plate main body 124a in the range of the second torsional angle θ2 and rotates integrally with the second driven plate main body 124a. That is, the second engaging member 21, to which each of the second friction members 19b is attached, rotates integrally with the driven plate 14 (the first driven plate main body 114a and the second driven plate main body 124a) and relatively rotates with respect to the drive plate 13 in the range of the second torsional angle θ2. In this case, substantially no hysteresis torque is generated between each of the second friction members 19b and the driven plate 14 (the first driven plate main body 114a); however, the first hysteresis torque is generated due to the mechanical friction of each component of the vibration reduction device 1.

Conversely, each of the second friction members 19b slides with the second driven plate main body 124a outside the range of the second torsional angle θ2. That is, the second engaging member 21, to which each of the second friction members 19b is attached, rotates integrally with the drive plate 13 and relatively rotates with respect to the driven plate 14 (the first driven plate main body 114a and the second driven plate main body 124a) outside the range of the second torsional angle θ2. In this case, the friction between each of the second friction members 19b and the driven plate 14 (first driven plate main body 114a) generates a third hysteresis torque.

<Dynamic Damper Device>

The dynamic damper device 5 absorbs torsional vibrations transmitted from the housing 2 to the main damper device 4. For example, when the torsional vibration of the engine is transmitted from the housing 2 to the main damper device 4, this torsional vibration is attenuated in the main damper device 4. Then, the torsional vibration output from the main damper device 4 is transmitted to the dynamic damper device 5. The dynamic damper device 5 absorbs this torsional vibration.

Note that the torsional vibration is vibration corresponding to a torque fluctuation (rotation speed variation). That is, the torsional vibration may include the meaning of torque fluctuation (rotation speed variation).

As shown in FIG. 1, the dynamic damper device 5 is disposed in the internal space S of the housing 2. The dynamic damper device 5 is disposed side by side with the main damper device 4 along the rotational axis O. In particular, the dynamic damper device 5 is disposed between the transmission and the main damper device 4 in the axial direction. More specifically, the dynamic damper device 5 is disposed between the second cover 10 of the housing 2 and the main damper device 4 in the axial direction.

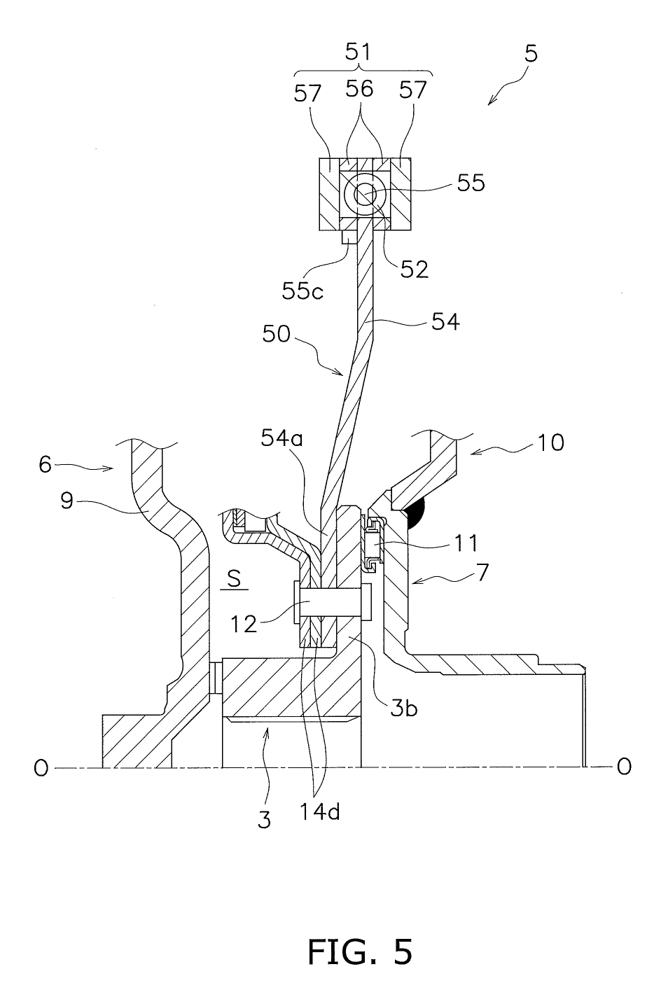

Specifically, as shown in FIG. 5, the dynamic damper device 5 includes a damper plate part 50 (an example of an input member), an inertia part 51 (an example of an inertia mass body), a plurality of damper springs 52 (for example, four; an example of a second elastic member), and a plurality of stop pins 53 (for example, eight).

(Damper Plate Part)

Torsional vibration output from the main damper device 4 is input to the damper plate part 50. In particular, as shown in FIG. 5, the torsional vibration output from the main damper device 4 (refer to FIG. 2) is input to the damper plate part 50 via the second hub flange 3b of the output hub 3.

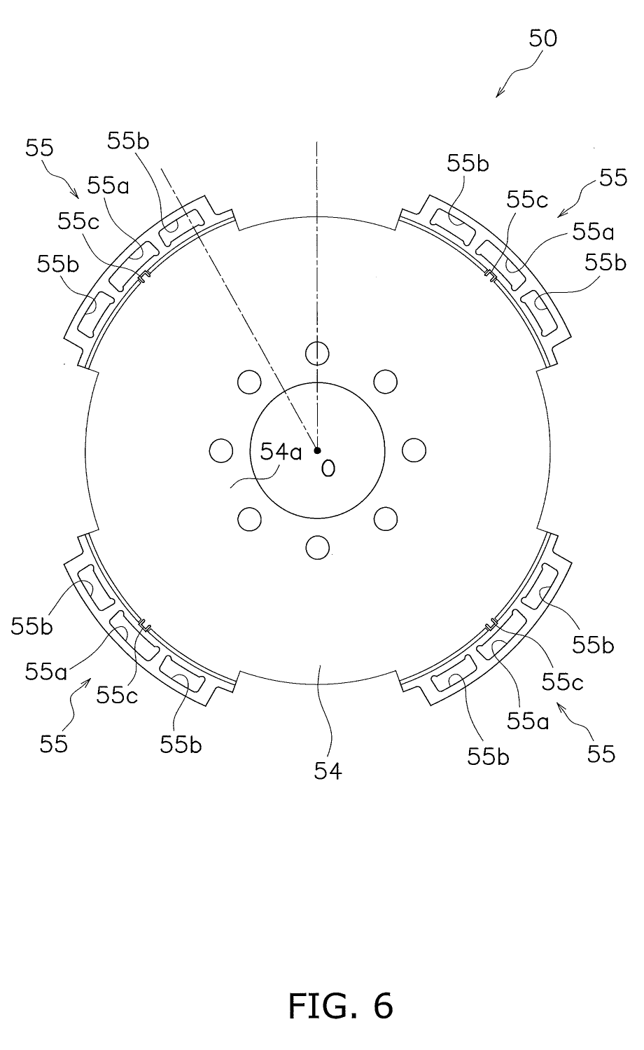

Specifically, as shown in FIGS. 5 and 6, the damper plate part 50 includes a damper plate main body 54 and a plurality of inertia engaging parts 1855 (four, for example).

The damper plate main body 54 is formed in a substantially annular shape. An inner peripheral part of the damper plate main body 54, for example, a second fixing part 54a is fixed to the second hub flange 3b of the output hub 3 by fixing means, for example, the plurality of rivets 12. More specifically, the second fixing part 54a of the damper plate main body 54 is fixed to the second hub flange 3b of the output hub 3 together with the first fixing part 14d of the pair of driven plate main bodies 14a by the plurality of rivets 12.

The plurality of inertia engaging parts 1855 are each integrally formed on the outer peripheral part of the damper plate main body 54. The plurality of inertia engaging parts 1855 are each disposed on the outer peripheral part of the damper plate main body 54 at predetermined intervals in the circumferential direction. Each of the inertia engaging parts 1855 protrudes radially outward from the outer peripheral part of the damper plate main body 54.

At least a part of each of the inertia engaging parts 1855 is disposed side by side with the plurality of coil springs 15 of the main damper device 4 in the axial direction. For example, at least a part of the inertia engaging part 1855 is disposed side by side with the outer peripheral side coil spring 15a in the axial direction. More specifically, a part of the inertia engaging part 1855 is disposed side by side with the outer peripheral side coil spring 15a in the axial direction.

Each of the inertia engaging parts 1855 includes a first spring storage part 55a, a plurality elongated holes 55b (for example, two), and a mate fitting part 55c.

Each of the first spring storage parts 55a is provided in each inertia engaging part 1855 at predetermined intervals in the circumferential direction. Each of the first spring storage parts 55a is formed to have a predetermined length in the circumferential direction. Each of the damper spring 52 is disposed in each of the first spring storage parts 55a.

The plurality of elongated holes 55b are formed in each of the inertia engaging parts 1855 on both sides of each of the first spring storage parts 55a in the circumferential direction. The plurality of elongated holes 55b have a predetermined length in the circumferential direction.

Each mate fitting part 55c is provided in each of the inertia engaging parts 1855 on the inner side of the first spring storage part 55a in the radial direction. Each mate fitting part 55c is formed by cutting and raising a part of each of the inertia engaging parts 1855.

(Inertia Part)

The inertia part 51 is configured to be relatively movable with respect to the damper plate part 50. Specifically, the inertia part 51 is configured to be relatively rotatable with respect the damper plate part 50.

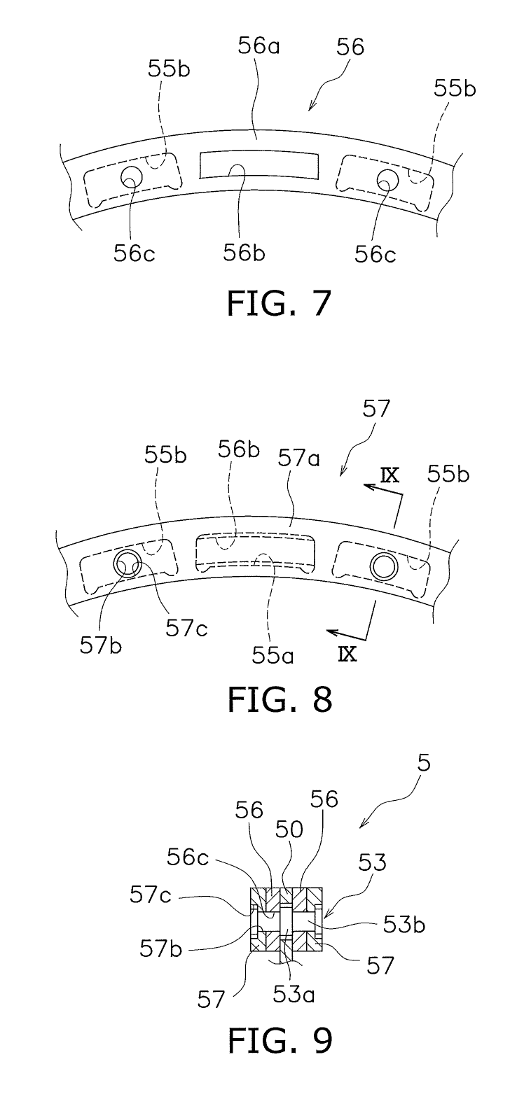

More specifically, as shown in FIGS. 5 and 7, the inertia part 51 includes a pair of inertia rings 56 and a pair of lid members 57.

The pair of inertia rings 56 is configured to be relatively rotatable with respect to the damper plate part 50. The inertia rings 56 are respectively disposed on both sides of the damper plate part 50 in the axial direction. The inertia rings 56 mutually have the substantially same configuration.

Each of the inertia rings 56 includes a ring main body 56a, a plurality of second spring storage parts 56b (for example, four in this case), and a plurality of first through holes 56c (for example, four in this case).

The ring main body 56a is formed in a substantially annular shape. The ring main body 56a is disposed on both sides of the inertia engaging part 1855 in the axial direction. In addition, similar to the above-described inertia engaging parts 1855, at least a part of the ring main body 56a is disposed side by side with the plurality of coil springs 15 of the main damper device 4 in the axial direction. For example, at least a part of the ring main body 56a is disposed side by side with the outer peripheral side coil spring 15a in the axial direction. More specifically, a part of the ring main body 56a is disposed side by side with the outer peripheral side coil spring 15a in the axial direction.

The second spring storage parts 56b are each provided in the ring main body 56a at predetermined intervals in the circumferential direction. Each of the second spring storage parts 56b is formed at a position corresponding to each of the first spring storage parts 55a of the damper plate part 50. The first through holes 56c are each formed in the ring body 56a at predetermined intervals in the circumferential direction. Each of the plurality of first through holes 56c is formed at a position corresponding to a center position in the circumferential direction inside each of the elongated holes 55b of the damper plate part 50.

The pair of lid members 57 is configured to be relatively rotatable with respect to the damper plate part 50 and integrally rotatable with the pair of inertia rings 56. As shown in FIG. 4, the lid members 57 are respectively disposed on both sides of the inertia rings 56 in the axial direction. The lid members 57 mutually have a substantially similar configuration.

Specifically, as shown in FIG. 7, the lid member 57 includes a lid body 57a, a second through hole 57b, and a third through hole 57c. The lid body 57a is formed in a substantially annular shape. The respective lid body 57a has inner and outer diameters that are the substantially same as the inner and outer diameters of the respective inertia rings 56 (ring main body 56a). The second through holes 57b are each formed in the lid main body 57a at predetermined intervals in the circumferential direction. Each of the second through holes 57b is formed at a position corresponding to each of the first through holes 56c of the inertia ring 56. Each of the third through holes 57c is formed coaxially with each of the second through holes 57b and larger in diameter than each of the second through holes 57b.

With this configuration in which the stop pins 53 are respectively inserted through the first through holes 56c of the inertia ring 56 and the second and third through holes 57b and 57c of the lid member 57, it is possible for the pair of lid members 57, together with the pair of inertia rings 56, to relatively rotate with respect to the damper plate unit 50. The structure of the respective stop pins 53 will be described later.

(Damper Spring)

As shown in FIG. 4, each of the plurality of damper springs 52 is, for example, the coil spring 15. The plurality of damper springs 52 are individually disposed in the first spring storage part 55a of the damper plate part 50 and the second spring storage part 56b of the inertia part 51. Both ends of each of the damper springs 52 respectively abut against wall parts of the first spring storage parts 55a and the second spring storage parts 56b in the circumferential direction. As a result, when the damper plate part 50 and the inertia part 51 rotate relative to each other, the damper springs 52 are compressed between the wall parts of the first spring storage part 55a and the wall parts of the second spring storage parts 56b in the circumferential direction.

(Stop Pin)

As shown in FIG. 8, each of the plurality of stop pins 53 includes a large-diameter shaft part 53a and a small-diameter shaft part 53b. The large-diameter shaft part 53a is provided on a center part of the stop pin 53 in the axial direction of the stop pin 53. The large-diameter shaft part 53a includes a diameter larger than a diameter of each of the first through holes 56c of the inertia ring 56 and also smaller than a diameter (a radial dimension) of each of the elongated holes 55b of the damper plate part 50.

The small-diameter shaft parts 53b are provided on both sides of the large-diameter shaft part 53a in the axial direction. Each of the small-diameter shaft parts 53b is inserted through each of the first through holes 56c of the inertia ring 56 and each of the second through holes 57b of the lid member 57. Fastening a head portion of the small-diameter shaft part 53b allows the head portion thereof to be disposed in each of the third through holes 57c. As a result, the inertia rings 56 and the lid members 57 are fixed axially to both sides of the damper plate part 50.

The above configuration allows the inertia part 51 (the inertia ring 56 and the lid member 57) to relatively rotate with respect to the damper plate part 50 in a range that the stop pin is movable in each of the elongated holes 55b of the damper plate part 50. When the large-diameter shaft part 53a of the stop pin 53 abuts against the end part of each of the elongated holes 55b, this abutment regulates the inertia part 51 (the inertia ring 56 and the lid member 57) from relatively rotating with respect to the damper plate part 50.

Further, in a state that the inertia part 51 (the inertia ring 56 and the lid member 57) is fixed by the stop pin 53, the inner peripheral surface of the inertia ring 56 abuts on the outer peripheral surface of the mate fitting part 55c of the damper plate part 50. With this configuration, the radial positioning of the inertia part 51 (the inertia ring 56 and the lid member 57) and the coil spring 15 is executed by the mate fitting part 55c.

<Operation of the Vibration Reduction Device>

When the torque of the engine is input to the housing 2, this torque is transmitted to the output hub 3 via the hysteresis torque generating mechanism 8 and the main damper device 4.

Specifically, the main damper device 4 and the hysteresis torque generating mechanism 8 operate in parallel to thereby transmit the torque, which has been input to the housing 2, to the output hub 3.

The torque is transmitted along a route of “the drive plate 13, the plurality of coil springs 15 (the plurality of outer peripheral side coil springs 15a and the plurality of inner peripheral side coil springs 15b) and the driven plate 14” in the main damper device 4.

Here, when the torque is input to the drive plate 13 of the main damper device 4 and the main damper device 4 operates within the range of the first torsional angle θ1, the drive plate 13 relatively rotates with respect to the engaging part 18 of the hysteresis torque generating mechanism 8 and to the driven plate 14. Then, each of the coil springs 15 (the outer peripheral side coil springs 15a and the inner peripheral side coil springs 15b) expands and contracts between the drive plate 13 and the driven plate 14. Hysteresis torque is virtually not generated in this state.

Next, the first hysteresis torque is generated when the main damper device 4 operates outside the range of the first torsional angle θ1 yet within the range of the second torsional angle θ2. For example, in this case, the drive plate 13 and the first engaging member 20 of the hysteresis torque generating mechanism 8 relatively rotate with respect to the driven plate 14. In this case, each of the first friction members 19a of the hysteresis torque generating mechanism 8 slides against the driven plate 14 (the first driven plate main body 114a). The first hysteresis torque is generated by the friction at this time, whereby the torsional vibration is attenuated by the first hysteresis torque. That is, in this case, the torsional vibration is attenuated by the first hysteresis torque.

In addition, when the main damper device 4 operates outside the range of the second torsional angle θ2, not only is the first hysteresis torque generated but the second hysteresis torque is also generated at the same time. For example, in this case, the drive plate 13 and the first engaging member 20 and the second engaging member 21 of the hysteresis torque generating mechanism 8 relatively rotate with respect to the driven plate 14. In this case, each of the first friction members 19a and each of the second friction members 19b of the hysteresis torque generating mechanism 8 slide against the driven plate 14 (the first driven plate main body 114a). The first hysteresis torque and the second hysteresis torque are generated by the friction at this time, whereby the torsional vibration is attenuated by the first hysteresis torque and the second hysteresis torque. That is, in this case, the torsional vibration is attenuated by the first hysteresis torque and the second hysteresis torque.

In addition, the output hub 3 is provided with the dynamic damper device 5 together with the main damper device 4. As a result, the dynamic damper device 5 can effectively suppress the torsional vibration (torque fluctuation/rotation speed variation) output from the main damper device 4.

For example, when the torsional vibration from the main damper device 4 is transmitted to the dynamic damper device 5, the inertia part 51 relatively rotates with respect to the damper plate part 50 via the plurality of damper springs 52. More specifically, the inertia part 51 rotates in a direction opposite to the rotation direction of the damper plate part 50 while the plurality of damper springs 52 are compressed and expanded by the input of the torsional fluctuation. That is, the inertia part 51 and the damper plate part 50 generate a phase difference in the rotation direction (circumferential direction). Due to the generation of the phase difference, the torsional vibration is absorbed by the dynamic damper device 5.

When the vibration reduction device 1 operates as described above, if the torsional vibration input to the housing 2 increases and the torsion angle of the main damper device 4 increases, the first hysteresis torque is generated outside the range of the first torsional angle θ1 and within the range of the second torsional angle θ2, and the second hysteresis torque is generated outside the range of the second torsional angle θ2.

In this way, gradually changing the hysteresis torque according to the torsional angle of the main damper device 4 makes it possible to effectively attenuate the torsional vibration. Consequently, each component of the vibration reduction device 1 can be appropriately operated, and the torsional vibration can be stably attenuated in each configuration of the vibration reduction device 1.

In addition, the torsional angle in the main damper device 4 increases at the resonance point of the vibration reduction device 1 (the main damper device 4 and the dynamic damper device 5), for example, in the vicinity of the secondary resonance point at the time of operation of the dynamic damper device 5. However, even if the torsional angle increases, it is possible to effectively attenuate the torsional vibration by gradually changing the hysteresis torque. In other words, the generation of excessive torsional vibration can be suppressed. That is, at the resonance point of the vibration reduction device 1 and in the vicinity of the resonance point, each component of the vibration reduction device 1 can be appropriately operated and the torsional vibration can be stably attenuated in each configuration of the vibration reduction device 1.

<Summary>

The aforementioned exemplary embodiment can also be described as follows.

(1) The vibration reduction device 1 is a device for reducing torsional vibration from an engine. The vibration reduction device 1 includes the housing 2, the output hub 3, the main damper device 4, the dynamic damper device 5, and the hysteresis torque generating mechanism 8. Torsional vibration is input to the housing 2. The output hub 3 is disposed so as to be relatively rotatable with respect to the housing 2. The main damper device 4 is disposed between the housing 2 and the output hub 3, and damps the torsional vibration input to the housing 2. The dynamic damper device 5 absorbs the torsional vibration output from the main damper device 4. The hysteresis torque generating mechanism 8 is configured to be capable of generating a hysteresis torque when the main damper device 4 is in operation.

In the present vibration reduction device 1, the hysteresis torque generation mechanism 8 generates the hysteresis torque when the main damper device 4 is in operation, and therefore excessive torsional vibration that can occur in the vibration reduction device 1 can be suppressed. As a result, the vibration reduction device 1 can be appropriately operated, and the torsional vibration can be stably attenuated in the vibration reduction device 1.

(2) In the vibration reduction device 1, the housing 2 constitutes the internal space S capable of containing lubricating oil. The main damper 4, the dynamic damper device 5, and the hysteresis torque generating mechanism 8 are disposed in the internal space S.

In this case, disposing the main damper device 4, the dynamic damper device 5, and the hysteresis torque generating mechanism 8 in the internal space S of the housing 2 in a state in which the lubricating oil is contained in the internal space S of the housing 2 makes it possible to stably operate the main damper device 4, the dynamic damper device 5, and the hysteresis torque generating mechanism 8.

(3) In the vibration reduction device 1, the hysteresis torque generating mechanism 8 operates in parallel with the main damper device 4. Operating the hysteresis torque generating mechanism 8 in this manner allows the hysteresis torque to be suitably generated at the time of operation of the damper part 4.

(4) In the vibration reduction device 1, the main damper device 4 includes the drive plate 13, the driven plate 14, and at least one coil spring 15. The drive plate 13 is coupled to the housing 2. The driven plate 14 is disposed so as to be relatively rotatable with respect to the drive plate 13 and is coupled to the output hub 3. At least one coil spring 15 elastically couples the drive plate 13 and the driven plate 14 to each other. The hysteresis torque generating mechanism 8 is disposed between the drive plate 13 and the driven plate 14. The hysteresis torque generating mechanism 8 generates a hysteresis torque according to the relative torsional angle of the drive plate 13 and the driven plate 14.

With this configuration in which the hysteresis torque generating mechanism 8 is configured in this manner, the hysteresis torque can be suitably generated at the time of operation of the main damper device 4.

(5) In the vibration reduction device 1 according to another aspect of the present disclosure, the hysteresis torque generating mechanism 8 includes the engaging part 18 and the friction part 19. The engaging part 18 engages with either one of the drive plate 13 or the driven plate 14. The friction part 19 is held between the engaging part 18 and either one of the other drive plate 13 or the other driven plate 14.

With this configuration in which the hysteresis torque generating mechanism 8 is configured in this manner, the hysteresis torque can be suitably generated at the time of operation of the main damper device 4.

(6) In the vibration reduction device 1 according to yet another aspect of the present disclosure, the engaging part 18 includes the first engaging member 20. The friction part 19 includes the first friction member 19a. The first engaging member 20 is relatively rotatable with respect to either one of the drive plate 13 or the driven plate 14 in the range of the first torsional angle θ1. The first engaging member 20 is integrally rotatable with either one of the drive plate 13 or the driven plate 14 outside the range of the first torsional angle θ1.

The first friction member 19a is slidable with respect to at least one of the first engaging member 20 and the other either one of the drive plate 13 or the driven plate 14 outside the range of the first torsional angle θ1.

With this configuration in which the hysteresis torque generating mechanism 8 is configured in this manner, the hysteresis torque can be suitably generated by the frictional resistance of the first friction member 19a outside the range of the first torsional angle θ1.

(7) In the vibration reduction device 1 according to yet another aspect of the present disclosure, the engaging part 18 further includes the second engaging member 21. The friction part 19 further includes the second friction member 19b. The second engaging member 21 is relatively rotatable with respect to either one of the drive plate 13 or the driven plate 14 in the range of the second torsional angle θ2 that is larger than the range of the first torsional angle θ1. The second engaging member 21 is integrally rotatable with either one of the drive plate 13 or the driven plate 14 outside the range of the second torsional angle θ2.

The second friction member 19b is slidable with respect to at least one of the second engaging member 21 and the other either one of the drive plate 13 or the driven plate 14 outside the range of the second torsional angle θ2.

With this configuration in which the hysteresis torque generating mechanism 8 is configured in this manner, the hysteresis torque can be suitably generated by the frictional resistance of the second friction member 19b outside the range of the second torsional angle θ2.

(8) In the vibration reduction device 1, the dynamic damper device 5 is disposed side by side with the main damper device 4 in the axial direction.

In this case, the dynamic damper device 5 can be effectively operated since the dynamic damper device 5 does not receive restrictions in the arrangement thereof due to the main damper 4. For example, it is possible to dispose the dynamic damper device 5 radially outward; thus allowing the dynamic damper device 5 to be effectively operated.

(9) In the vibration reduction device 1, the main damper device 4 includes the drive plate 13, the driven plate 14, and at least one coil spring 15. The drive plate 13 is coupled to the housing 2. The driven plate 14 is disposed so as to be relatively rotatable with respect to the drive plate 13. The driven plate 14 is coupled to the output hub 3. At least one coil spring 15 elastically couples the drive plate 13 and the driven plate 14 to each other.

Even if the main damper device 4 is constituted in the manner now being exemplified, the vibration reduction device 1 can be appropriately operated, and the torsional vibration can be stably attenuated in the vibration reduction device 1.

(10) In the vibration reduction device 1, the dynamic damper device 5 includes the damper plate part 50, the inertia part 51, and at least one damper spring 52. Torsional vibration output from the main damper device 4 is input to the damper plate part 50. The inertia part 51 is configured to be relatively movable with respect to the damper plate part 50. At least one damper spring 52 elastically couples the damper plate part 50 and the inertia part 51 with each other.

Even if the dynamic damper device 5 is configured in the manner now being exemplified, the vibration reduction device 1 can be appropriately operated and the torsional vibration can be stably attenuated in the vibration reduction device 1.

### Other Exemplary Embodiments

The present disclosure is not limited to the exemplary embodiment described above, and a variety of changes and modifications can be made herein without departing from the scope of the disclosure.

(a) In the aforementioned exemplary embodiment, the exemplified case is that the hysteresis torque generating mechanism 8 generates the first hysteresis torque and the second hysteresis torque; however, a configuration can be adopted in which only one of the first hysteresis torque and the second hysteresis torque is generated. In this case, this configuration can be realized by using only one of either the first engaging member 20 and the first friction member 19a or the second engaging member 21 and the first friction member 21b.

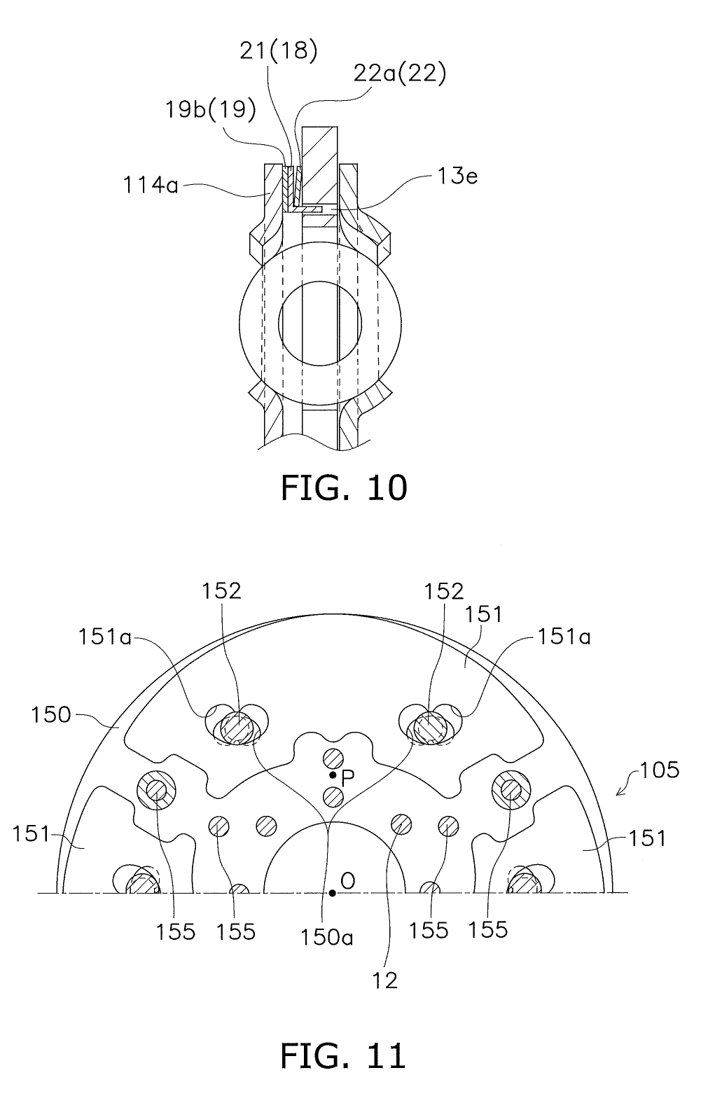

(b) In the aforementioned exemplary embodiment, the exemplified case is that the hysteresis torque generating mechanism 8 includes the engaging part 18 and the friction part 19. Alternatively, as shown in FIG. 10, the hysteresis torque generating mechanism 8 can further include a pressing part 22 for pressing the engaging part 18.

For example, the pressing part 22 includes a cone spring 22a. The cone spring 22a is disposed between the second engaging member 21 and the first driven plate main body 114a in the axial direction. The cone spring 22a is relatively rotatable with respect to at least one of either the second engaging member 21 or the first driven plate main body 114a. With this configuration, the second friction member 19b is held between the second engaging member 21 and the first driven plate main body 114a. Even if configured as such, it is possible to obtain the same effect as described above.

Note that the above exemplified case shows that the cone spring 22a is disposed between the second engaging member 21 and the first driven plate main body 114a in the axial direction. However, the above cone spring 22a can be disposed between the first engaging member 20 and the first driven plate main body 114a in the axial direction.

(c) In the aforementioned exemplary embodiment, the exemplified case is that the first engaging protrusion 20b and the second engaging protrusion 21b are separately disposed in the second hole 13f and the first hole 13e of the driven plate 14, respectively. Alternatively, at least one of the second hole 13f and the first hole 13e can be provided in the drive plate 13.

(d) In the aforementioned exemplary embodiment, the exemplified case is that the main damper device 4 is disposed closer to the engine side than the dynamic damper device 5 in the axial direction. Alternatively, the dynamic damper device 5 can be disposed closer to the engine side than the main damper device 4 in the axial direction.

In this case, the dynamic damper device 5 is disposed between the engine and the main damper device 4 in the axial direction. Specifically, the dynamic damper device 5 is disposed between the housing 2 on the engine side and the main damper device 4 in the axial direction. More specifically, the main damper device 5 is disposed between the first cover 9 of the housing 2 and the main damper device 5 in the axial direction. Even if configured as such, the same effect as the above exemplary embodiment can be obtained.

(e) The main damper device 4 of the aforementioned exemplary embodiment is shown as an example of the main damper device 4; the configuration of the main damper device 4 can be configured in any way.

For example, the main damper device 4 can be configured in any way as long as the configuration thereof includes the drive plate 13 coupled to the housing 2, the driven plate 14 which is disposed so as to be relatively rotatable with respect to the drive plate 13 and is coupled to the output hub 3, and at least one coil spring 15 for elastically coupling the drive plate 13 and the driven plate 14.

(f) The dynamic damper device 5 of the aforementioned exemplary embodiment is shown as an example of the dynamic damper device 5; the configuration of the dynamic damper device 5 can be configured in any way.

For example, the dynamic damper device 5 can be configured in any way as long as the configuration thereof includes the damper plate part 50 to which torsional vibration output from the main damper device 4 is input, the inertia part 51 configured to be relatively movable with respect to the damper plate part 50, and at least one damper spring 52 for elastically coupling damper plate part 50 and the inertia part 51.

(d) The dynamic damper device 5 of the aforementioned exemplary embodiment is shown as an example of a dynamic vibration absorbing device; the configuration of the dynamic damper device 5 can be configured in any way.

For example, as shown in FIG. 11, a configuration can be adopted in which a dynamic damper device 105 is constituted. In this case, the dynamic damper device 105 includes a pair of damper plate parts 150 and a plurality of inertia parts 151. One of the damper plate parts 150 is fixed to the output hub 3 (the second hub flange 3b) by the plurality of rivets 12. The other of damper plate parts 150 (not shown) is disposed so as to face one of the damper plate parts 150 in the axial direction, and is fixed to one of the damper plate parts 150 by a plurality of rivets 155.

Each of the plurality of inertia parts 151 is disposed between the pair of damper plate parts 150 in the axial direction and is supported so as to be pivotable with respect to the pair of damper plate parts 150. Specifically, each of the plurality of inertia potions 151 is pivotably supported by the pair of damper plate parts 150 using the plurality of pin members 152 (for example, two).

The pin members 152 are respectively inserted through the first elongated holes 150a of the pair of damper plate parts 150 and the second elongated holes 151a of the inertia part 151. The central part of the first elongated hole 150a has a bulge shape toward the outer peripheral side and is formed in a substantially circular arc shape. The central part of the second elongated hole 151a has a bulge shape toward the inner peripheral side and is formed in a substantially circular arc shape.

In this configuration, when the torsional vibration from the main damper device 4 is transmitted to the dynamic damper device 105, each of the inertia parts 151 pivots with respect to the damper plate part 150 via the pin member 152.

In this case, a pivot center P of each of the inertia parts 151 is provided farther radially outward than the rotational axis O. Each of the inertia parts 151 pivots with respect to the damper plate part 150 with reference to the pivot center P.

More specifically, each of the inertia parts 151 pivots with reference to the pivot center P so as to suppress the rotation of the damper plate part 150. With this configuration, the torsional vibration is absorbed by the dynamic damper device 105.

(e) The dynamic damper device 5 of the aforementioned exemplary embodiment is shown as an example of a dynamic vibration absorbing device; the configuration of the dynamic damper device 5 can be configured in any way.

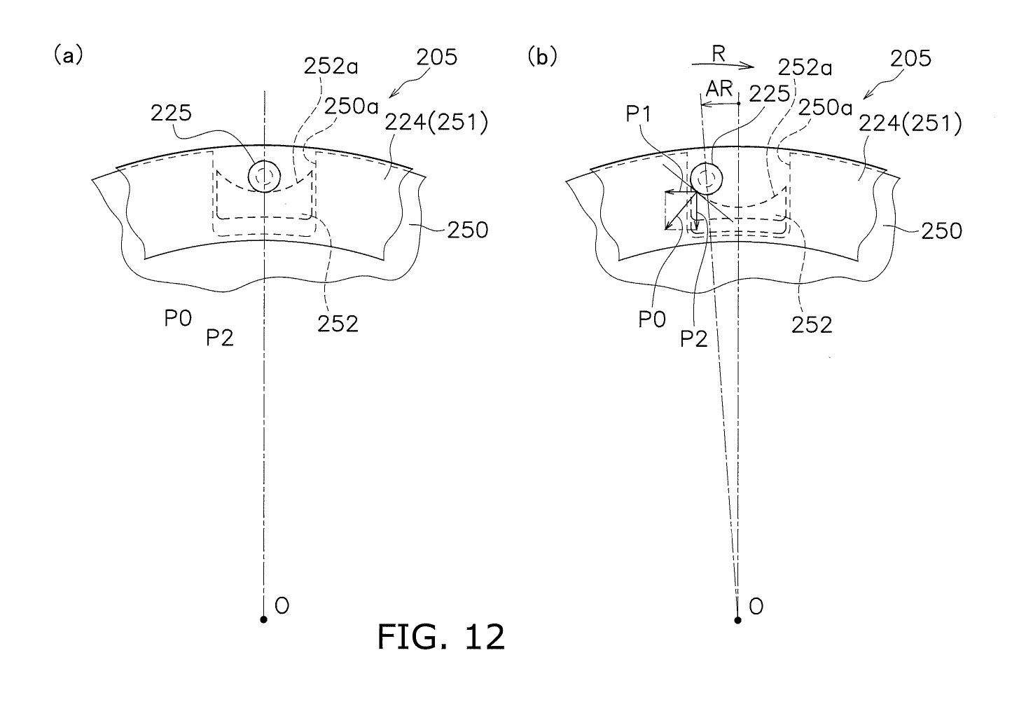

For example, as shown in FIG. 12, a configuration can be adopted in which a dynamic damper device 205 is configured. In this case, the dynamic damper device 205 includes a damper plate part 250, an inertia part 251 (for example, a pair of inertia), and a plurality of centrifugal elements 252. The damper plate part 250 is fixed to the output hub 3 (the second hub flange 3b) by the plurality of rivets 12 (refer to FIGS. 2 and 3).

The inertia part 251 is configured to be relatively rotatable with respect to the damper plate part 250. The inertia part 251 includes a pair of inertia rings 224 and a pin member 225 for coupling the pair of inertia rings 224. The damper plate part 250 is disposed between the pair of inertial rings in the axial direction.

The centrifugal element 252 is engaged with the inertia part 251 by the centrifugal force. The centrifugal element 252 guides the inertia part 251 so that the relative displacement between the damper plate part 250 and the inertia part 251 is reduced.

Specifically, each of the centrifugal members 252 is disposed in each of the plurality of recess parts 250a of the damper plate part 250 so as to be movable in the radial direction by the centrifugal force. A cam surface 252a is formed on the radially outer surface of each of the centrifugal elements. Each of the pin members 225 can abut on each of the cam surfaces 252a. In a state in which each pin member 225 abuts with each cam surface 252a, each pin member 225 is movable along each cam surface 252a.

It should be noted that each of the pin members 225 includes a shaft part whose both end parts are respectively fixed to each of the pair of inertia parts 251, and a roller part that is rotatable around the shaft part. Here, the roller part is in contact with the cam surface 252a.

In this configuration, as shown in FIG. 12A, when each centrifugal element 252 moves radially outward by the centrifugal force, the cam surface 252a of each centrifugal 252 abuts on each pin member 225. When the torsional vibration from the main damper device 4 is transmitted to the dynamic damper device 205 in this state, as shown in FIG. 12B, the inertia part 251 (the pair of inertia rings 224) relatively moves in the circumferential direction with respect to the damper plate part 250. At this time, while each centrifugal member 252 moves radially inward, each pin member 225 moves along the cam surface 252a of each of the centrifugal members 252 in the rotational direction (opposite direction AR) opposite to the rotational direction of the damper plate part 250. That is, the inertia part 251 (the pin member 225) moves in the opposite direction AR.

At this time, each pin member 225 presses the cam surface 252a of each centrifugal element 252. For example, a pressing force PO in FIG. 12B acts on the cam surface 252a of each centrifugal element 252 from each pin member 225. Then, the damper plate part 250 (each centrifugal member 252) is pulled back in the above-mentioned opposite direction AR by a component force P1 of the pressing force P0. Thus, each centrifugal element 252 guides the inertia part 251 so that the relative displacement between the damper plate part 250 and the inertia part 251 is reduced. In other words, the inertia part 251 suppresses the rotation of the damper plate part 250 via each centrifugal member 252. With this configuration, the torsional vibration is absorbed by the dynamic damper device 205.

### REFERENCE SIGNS LIST

1 Vibration reduction device
2 Housing
3 Output hub
4 Main damper device
5 Dynamic damper device
8 Hysteresis torque generating mechanism
13 Drive plate
14 Driven plate
15 Coil spring
18 Engaging part
19 Friction part
19a First friction member
19b Second friction member
20 First engaging member
21 Second engaging member
50 Damper plate part
51 Inertia part
52 Damper spring
θ1 First torsional angle θ2 Second torsional angle
S Internal space
O Rotational axis

1. A vibration reduction device for reducing a torsional vibration from an engine, the vibration reduction device comprising:
an input rotary part to which the torsional vibration is input;
an output rotary part disposed to be relatively rotatable with respect to the input rotary part;
a damper part that is disposed between the input rotary part and the output rotary part and attenuates the torsional vibration input to the input rotary part;
a dynamic vibration absorbing device for absorbing the torsional vibration output from the damper part; and
a hysteresis torque generating part configured to be capable of generating a hysteresis torque when the damper part is in operation.

2. The vibration reduction device according to claim 1, wherein
the input rotary part constitutes an internal space capable of containing lubricating oil, and
the damper part, the hysteresis torque generating part, and the dynamic vibration absorbing device are disposed in the internal space.

3. The vibration reduction device according to claim 1, wherein
the hysteresis torque generating part operates in parallel with the damper part.

4. The vibration reduction device according to claims 1, wherein
the damper part includes
a first rotary member coupled to the input rotary part,
a second rotary member disposed so as to be relatively rotatable with respect to the first rotary member and coupled to the output rotary part, and
a first elastic member that elastically couples the first rotary member and the second rotary member to each other; and
the hysteresis torque generating part is disposed between the first rotary member and the second rotary member and generates the hysteresis torque according to a relative torsional angle of the first rotary member and the second rotary member.

5. The vibration reduction device according to claim 4, wherein
the hysteresis torque generating part includes
an engaging part that is engaged with either one of the first rotary member or the second rotary member, and
a friction part that is held between the engaging part and the other one of either the first rotary member or the second rotary member.

6. The vibration reduction device according to claim 5, wherein
the engaging part includes a first engaging member, and
the friction part includes a first friction member,
the first engaging member relatively rotatable with respect to either one of the first rotary member or the second rotary member in a range of a first torsional angle and integrally rotatable with either one of the first rotary member or the second rotary member outside the range of the first torsional angle,
the first friction member slidable with respect to at least one of the first engaging member and the other of either one of the first rotary member or the second rotary member outside the range of the first torsional angle.

7. The vibration reduction device according to claim 6, wherein
the engaging part further includes a second engaging member, and
the friction part further includes a second friction member,
the second engaging member relatively rotatable with respect to either one of the first rotary member or the second rotary member in a range of a second torsional angle that is larger than the range of the first torsional angle and integrally rotatable with either one of the first rotary member or the second rotary member outside the range of the second torsional angle,
the second friction member slidable with respect to at least one of the second engaging member and the other of either one of the first rotary member of the second rotary member outside the range of the second torsional angle.

8. The vibration reduction device according to claim 1, wherein
the dynamic vibration absorbing device is disposed side by side with the damper part in a direction along a rotational axis of the input rotary part.

9. The vibration reduction device according to claim 1, wherein
the damper part includes
a first rotary member coupled to the input rotary part,
a second rotary member disposed relatively rotatable with respect to the first rotary member and coupled to the output rotary part, and
a first elastic member that elastically couples the first rotary member and the second rotary member to each other.

10. The vibration reduction device according to claim 1, wherein
the dynamic vibration absorbing device includes
an input member to which the torsional vibration output from the damper part is input, and
an inertia mass body configured to be relatively movable with respect to the input member.

11. The vibration reduction device according to claim 10, wherein
the dynamic vibration absorbing device further includes a second elastic member that elastically couples the input member and the inertia mass body.

12. The vibration reduction device according to claim 10, wherein
each of a plurality of inertia mass bodies is pivotably supported by the input member with reference to a pivot center that is farther radially outward than the rotational axis of the input rotary part.

13. The vibration reduction device according to claim 10, wherein
the dynamic vibration absorbing device further includes a centrifugal element for engaging with the inertia mass body by a centrifugal force and guiding the inertia mass body so that a relative displacement between the input member and the inertia mass body is reduced.
